(19) United States
(12) Patent Application Publication
(10) Pub. No.: US 2025/0186934 A1
(43) Pub. Date: Jun. 12, 2025

(54) INTEGRATED HYDROGEN PRODUCTION AND CARBON DIOXIDE RECOVERY PROCESS

(71) Applicant: UOP LLC, Des Plaines, IL (US)

(72) Inventors: Lin Jin, Inverness, IL (US); John D. Wilkinson, Midland, TX (US); Bradley Russell, Fall Branch, TN (US); Oluwaseyi Kayode, Houston, TX (US); Erick J. Bennett, III, Naperville, IL (US); Shubhra J. Bhadra, Naperville, IL (US)

(21) Appl. No.: 18/536,631

(22) Filed: Dec. 12, 2023

(51) Int. Cl. B01D 53/047; B01D 53/14; B01D 53/75

(52) U.S. Cl. CPC B01D 53/047; B01D 53/1418; B01D 53/75; B01D 2257/504; B01D 2259/416

(57) ABSTRACT

Integrated processes for hydrogen production and carbon dioxide recovery are described. The processes use a chilling stream in a cryogenic carbon dioxide recovery unit. The chilling stream chills a working fluid which chills the hydrogen-depleted tail gas stream from a hydrogen pressure swing adsorption (PSA) unit to form a carbon dioxide product stream.

### BACKGROUND

Hydrogen is expected to have significant growth potential because it is a clean-burning fuel. However, hydrogen production is traditionally a significant emitter of CO₂, and government regulations and societal pressures are increasingly taxing or penalizing CO₂ emissions or incentivizing CO₂ capture. Consequently, significant competition to lower the cost of hydrogen production while recovering the byproduct CO₂ for subsequent geological sequestration to capture the growing market is anticipated. A method for achieving this objective is to add CO₂ capture to the process along with conversion of unconverted carbon-containing components (carbon monoxide and methane) to carbon dioxide within the process. CO₂ can be recovered as a high-pressure gas to be supplied to a pipeline, but often it is produced in liquefied form for easy transport by truck or ship due to the current lack of CO₂ pipeline infrastructure in certain areas of the world.

Hydrogen facilities with carbon capture require large quantities of heat for the reforming reaction as well as work in the form of steam or electricity to drive the numerous compressors required to sequester the captured CO₂. The electricity and fuel requirements often lead to increases in the carbon intensity and therefore limit the profitability of the technology.

Many existing hydrogen production processes utilize pressure swing adsorption (PSA) units to recover high-purity product hydrogen from shifted syngas. The PSA unit also produces a low-pressure hydrogen-depleted tail gas stream comprising carbon dioxide, carbon monoxide, methane and some hydrogen. The hydrogen-depleted stream is compressed and dried, and the dried compressed tail gas stream is separated in a carbon dioxide separation unit into a carbon dioxide product stream and an overhead stream.

There are a variety of carbon dioxide separation units used for carbon capture. Cryogenic carbon dioxide separation units are one type, and they can utilize mixed refrigerants. Typically electric power is used to compress the mixed refrigerant (MR) in multi-stage mixed refrigerant (MR) compressors. The compressed vapor is fully condensed in the MR compressor cooler by cooling water, then followed by further cooling in the main heat exchanger. The cooled mixed refrigerant is then let down through a valve to provide cooling duty.

However, the multiple compressors used in this process are expensive to purchase and operate.

Therefore, there is a need for improved hydrogen production processes with reduced capital and operating costs.

### BRIEF DESCRIPTION OF THE DRAWINGS

FIG. 1 is an illustration of a hydrogen production process producing hydrogen and recovering carbon dioxide incorporating a cryogenic carbon dioxide separation unit using a chilling stream.

### DESCRIPTION

The present invention utilizes a chilling stream in a cryogenic carbon dioxide separation unit. A working fluid stream is chilled with the chilling stream in a chilling stream-working fluid heat exchanger. The chilled working fluid is sent to the cold side of the main heat exchanger to provide the cold duty of the cryogenic fractionation column. The warmed working fluid exits the main heat exchanger and is returned to the chilling stream-working fluid heat exchanger. The chilling stream may comprise liquefied natural gas, or liquid nitrogen, or ammonia, or liquid hydrogen, or combinations thereof.

Because of the cold temperature of the chilling stream, e.g., −253 to −70° C., if the temperature of the chilling stream is less than the freezing temperature of carbon dioxide, the working fluid should be free of carbon dioxide; otherwise, the carbon dioxide would freeze.

The working fluid is pumped back to the chilling stream-working fluid heat exchanger, which significantly reduces the leak rate as compared to a multi-stage mixed refrigerant compressor, and, which significantly reduces overall operating costs through lower electrical power consumption and lower working fluid loss rates resulting in a lower working fluid make up operating expense. In addition, the capital cost is reduced because no compressor is needed. Furthermore, other streams, including, but not limited to, the hydrogen PSA feed stream or the dehydration unit feed stream, can be chilled with the warmed working fluid before being passed to the reformer or the natural gas grid.

If a non-flammable working fluid, e.g., a hydrofluoroolefin refrigerant, such as Solstice® (available from Honeywell), is used, safety concerns with mixed refrigerants which are currently used containing carbon dioxide, propane and isopentane are eliminated.

Any suitable working fluid can be used. Suitable working fluids include, but are not limited to, hydrofluoroolefins, hydrocarbons having 1 to 5 carbon atoms, such as alkanes and alkenes having 1 to 5 carbon atoms, or combinations thereof. Suitable hydrofluoroolefins include, but are not limited to, trans-1-chloro-3,3,3-trifluoropropene, (available from Honeywell under the name Solstice® ZD, Solstice® 1233zd (E), for example) or combinations thereof. Suitable hydrocarbons include, but are not limited to, ethane, ethylene, propane, propylene, butane, isopentane, or combinations thereof.

The process may further comprise separating the overhead stream in an overhead PSA unit to form a low-pressure carbon dioxide stream enriched in carbon dioxide and an off-gas stream enriched in hydrogen and at least one of carbon monoxide and methane; and optionally recycling the low-pressure carbon dioxide stream to the cryogenic carbon dioxide separation unit.

The process may further comprise separating the off-gas stream in a second overhead PSA unit to form a second hydrogen product stream and a second off-gas stream enriched in at least one of carbon monoxide and methane.

The process may further comprise passing the second off-gas stream to the synthesis gas production zone.

The process may further comprise passing at least a portion of the second hydrogen product stream to a process unit as fuel gas.

In some embodiments, separating the synthesis gas in the hydrogen PSA unit to form the high-pressure hydrogen product stream enriched in hydrogen and the hydrogen-depleted tail gas stream comprises separating the synthesis gas in the hydrogen PSA unit to form the high-pressure hydrogen product stream enriched in hydrogen, the hydrogen-depleted tail gas stream, and a fuel gas stream, and the process further comprises: passing the fuel gas stream to a process unit as fuel gas.

The process may further comprise chilling a process stream with the chilling stream after chilling the working fluid stream.

In some embodiments, the process stream comprises the synthesis gas stream, a feed stream to a dehydration unit, a compressor discharge stream, or combinations thereof.

In some embodiments, the chilling gas comprises liquified natural gas, and the process may further comprise: passing the warmed natural gas to the synthesis gas production unit after chilling the working fluid stream; or passing the warmed natural gas to a natural gas network after chilling a working fluid stream; or both.

The process may further comprise: compressing and drying the hydrogen-depleted tail gas stream to form a dried compressed tail gas stream; and wherein chilling the hydrogen-depleted tail gas stream with the chilled working fluid stream comprises chilling the dried compressed tail gas stream with the chilled working fluid stream.

The process may further comprise: removing at least a portion of the water from the synthesis gas stream before separating the synthesis gas in the hydrogen PSA unit. One way to do this is to cool the synthesis gas stream with the chilling gas followed by separation in a knockout drum.

Any suitable heat exchanger can be used. The heat exchanger should be designed for operation at temperatures in the range of −162° C. to 40° C., pressures in the range of 4 MPa (a) to 11 MPa (a), and change in temperature in the range of −162° C. to 20° C. Suitable heaters include, but are not limited to, printed circuit heat exchangers, shell and tube exchangers, brazed aluminum exchangers, spiral wound heat exchangers, or combinations thereof.

Another aspect of the invention is an integrated process for hydrogen production and carbon dioxide recovery. In one embodiment, the process comprises: introducing a feed stream comprising hydrocarbons or a carbonaceous feedstock to a synthesis gas production zone comprising a syngas reactor to produce a synthesis gas stream comprising hydrogen, carbon dioxide, carbon monoxide, and methane; separating the synthesis gas stream in a hydrogen pressure swing adsorption (PSA) unit to form a high-pressure hydrogen product stream enriched in hydrogen and a hydrogen-depleted tail gas stream; compressing and drying the hydrogen-depleted tail gas stream to form a dried compressed tail gas stream; chilling a working fluid stream with a chilling stream comprising liquefied natural gas, or liquid nitrogen, or ammonia, or liquid hydrogen, or combinations thereof in a heat exchanger forming a chilled working fluid stream, the working fluid stream being free of carbon dioxide; chilling the dried compressed tail gas stream with the chilled working fluid stream in a cryogenic carbon dioxide separation unit to separate the chilled hydrogen-depleted tail gas stream into a carbon dioxide product stream comprising carbon dioxide, and an overhead stream, thereby warming the working fluid stream; passing the working fluid stream to the heat exchanger; separating the overhead stream in an overhead PSA unit to form a low-pressure carbon dioxide stream enriched in carbon dioxide and an off-gas stream enriched in hydrogen and at least one of carbon monoxide and methane; and optionally recycling the low-pressure carbon dioxide stream to the cryogenic carbon dioxide separation unit.

In some embodiments, the working fluid stream comprises a hydrofluoroolefin, a hydrocarbon having 1 to 5 carbon atoms, such as alkanes and alkenes having 1 to 5 carbon atoms, or combinations thereof.

The process may further comprise: separating the off-gas stream in a second overhead separation unit to form a second hydrogen product stream and a second off-gas stream enriched in at least one of carbon monoxide and methane; optionally passing the second off-gas stream to the synthesis gas production zone; optionally passing at least a portion of the second hydrogen product stream to a process unit as fuel gas. Suitable overhead separation units for this separation include, but are not limited to, PSA units, or membrane separation units, or combinations thereof.

The process may further comprise: chilling a process stream with the chilling stream after chilling the working fluid stream wherein the process stream comprises the synthesis gas stream, a feed stream to a dehydration unit, a compressor discharge stream, or combinations thereof.

In some embodiments, the chilling gas comprises liquified natural gas, and the process further comprises: passing the liquefied natural gas to the synthesis gas production unit after chilling the working fluid stream; or passing the liquefied natural gas to a natural gas network after chilling a working fluid stream; or both.

In some embodiments, the heat exchanger comprises a printed circuit heat exchanger, a shell and tube exchanger, a brazed aluminum exchanger, a spiral wound heat exchanger, or combinations thereof.

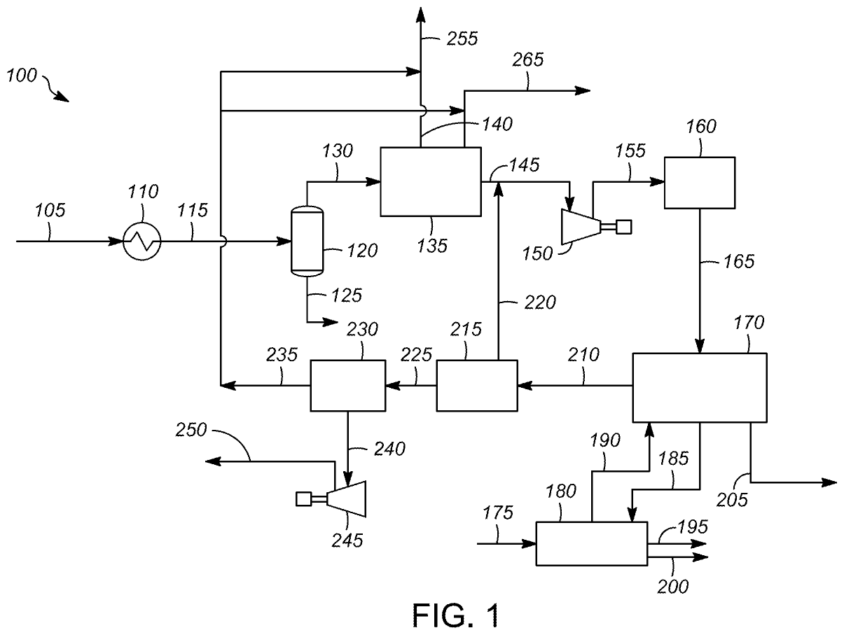

FIG. 1 illustrates one embodiment of the process 100. The synthesis gas stream 105 is chilled in inlet gas chiller 110. The chilled synthesis gas stream 115, which has a temperature of about 0° C. to about 40° C., is sent to a knockout pot 120 where a water stream 125 is removed resulting in a chilled synthesis gas stream 130 having a lower level of water than the incoming chilled synthesis gas stream 115. In cases where methanol or ammonia is present in the synthesis gas stream 105, a portion of the methanol or ammonia will be removed with water stream 125.

The chilled synthesis gas stream 130 is sent to the hydrogen PSA unit 135 where it is separated into a high-pressure hydrogen product stream 140 and a low-pressure hydrogen-depleted tail gas stream 145.

The high-pressure hydrogen product stream 140 may have a temperature of 10 to 50° C. and a pressure of 20 to 40 bar (g), and it may contain 99.0 to 99.999 mol % hydrogen, less than 1 ppmv carbon dioxide, less than 1 ppmv to 1000 ppmv methane, less than 1 ppmv to 50 ppmv carbon monoxide, 0 to 2000 ppmv nitrogen, less than 1 ppmv water, 0 to 3000 ppmv argon, and less than 0.1 ppmv methanol.

The low-pressure hydrogen-depleted tail gas stream 145 may have a temperature of 0 to 40° C. and a pressure of 0.2 to 0.5 bar (g), and it may contain 20 to 30 mol % hydrogen, 55 to 75 mol % carbon dioxide, 2 to 15 mol % methane, 1 to 15 mol % carbon monoxide, 0 to 2 mol % nitrogen, 1 to 2 mol % water, 0 to 0.4 mol % argon, and 0 to 1000 ppmv methanol.

The low-pressure hydrogen-depleted tail gas stream 145 is compressed in tail gas compressor 150 from a pressure in the range of about 110 kPa to about 200 kPa to a pressure in the range of about 3,000 kPa to about 5,000 kPa. The compressed tail gas stream 155 is dried in drier 160, and the compressed, dried tail gas stream 165 is sent to a sent to a carbon dioxide separation unit 170.

A chilling stream 175 is sent to a heat exchanger 180 where it exchanges heat with a refrigerant stream 185 producing a chilled working fluid stream 190 and one or more warmed chilling streams 195, 200. For example, warmed chilling stream 195 may have a pressure of about 5 MPa and be sent to the synthesis gas production zone as feed, and warmed chilling stream 200 may have a pressure of about 10 MPa and be sent to the natural gas grid.

The compressed, dried tail gas stream 165 is separated into the carbon dioxide-enriched product stream 205 and an overhead stream 210. The carbon dioxide-enriched product stream 205 can be recovered.

The overhead stream 210 may have a temperature of 20 to 40° C. and a pressure of 3,000 to 5,000 kPa, and it may contain 50 to 80 mol % hydrogen, 10 to 20 mol % carbon dioxide, 5 to 20 mol % methane, 5 to 20 mol % carbon monoxide, 0 to 20 mol % nitrogen, and 0 to 1 mol % argon.

The overhead stream 210 is sent to a second PSA unit 215 to form a low-pressure carbon dioxide stream 220 enriched in carbon dioxide and a third off-gas stream 225 enriched in hydrogen and at least one of carbon monoxide, methane, nitrogen, and argon.

The low-pressure carbon dioxide stream 220 may have a temperature of 0 to 30° C. and a pressure of 0.3 to 0.5 bar (g), and it may contain 10 to 20 mol % hydrogen, 60 to 80 mol % carbon dioxide, 2 to 10 mol % methane, 2 to 10 mol % carbon monoxide, 0 to 10 mol % nitrogen, and 0 to 0.5 mol % argon. The third off-gas stream 225 may have a temperature of 30 to 40° C. and a pressure of 3,000 to 5,000 kPa, and it may contain 50 to 90 mol % hydrogen, 0.01 to 0.5 mol % carbon dioxide, 5 to 30 mol % methane, 5 to 30 mol % carbon monoxide, 0 to 20 mol % nitrogen, and 0 to 1 mol % argon.

The third off-gas stream 225 is sent to a third PSA unit 230 where it is separated into a second hydrogen product stream 235 and a second tail gas stream 240. The second tail gas stream 240 is compressed in second compressor 245, and the compressed second tail gas stream 250 is sent to synthesis gas production zone as feed. Alternatively, the third off-gas stream 225 could be compressed and sent to the synthesis gas production zone as feed (not shown). It could also be sent to a membrane separation unit (not shown). In that case, the permeates stream can be used as fuel, and the residue can be compressed and sent to the synthesis gas production zone as feed.

The high-pressure hydrogen product stream 140 from the hydrogen PSA unit 135 and all or a portion of the second hydrogen product stream 235 from the third PSA unit 230 may be combined as combined hydrogen product stream 255. All or a portion of the second hydrogen product stream 235 may be combined with a fuel gas stream 265 from the hydrogen PSA unit 135 and used as fuel gas.

### EXAMPLES

A comparison was made between cryogenic CO₂ fractionation with mixed refrigerant system and a system using a chilling liquid to provide cold duty required for the cryogenic CO₂ fractionation. The mixed refrigerant system included a multi-stage mixed refrigerant compressor, interstage cooler, after cooler, and knockout drums. The chilling liquid system used liquefied natural gas as the chilling stream, a mixture of ethane, propane, and isopentane as the working fluid, and a printed circuit heat exchanger as the heat exchanger between the chilling stream and the working fluid stream. The process simulation was performed using Honeywell's UniSim Design Suite. In order to produce 200 MMSCFD chemical grade hydrogen from autothermal reformer (ATR) synthesis gas reactor with capture of CO₂ with a cryogenic CO₂ fractionation process, it was estimated there would be 12 MW savings in power to provide chilling duty with a chilling stream compared to the chilling process with the mixed refrigerant compressor. In addition, it was estimated that there would be about $10 M in equipment cost saving on mixed refrigerant compressors and inter-stage cooling and after cooling systems using the chilling stream compared to the mixed refrigerant process.

### Specific Embodiments

While the following is described in conjunction with specific embodiments, it will be understood that this description is intended to illustrate and not limit the scope of the preceding description and the appended claims.

A first embodiment of the invention is a process for hydrogen production and carbon dioxide recovery comprising introducing a feed stream comprising hydrocarbons or a carbonaceous feedstock to a synthesis gas production zone comprising a syngas reactor to produce a synthesis gas stream comprising hydrogen, carbon dioxide, carbon monoxide, and methane; separating the synthesis gas stream in a hydrogen pressure swing adsorption (PSA) unit to form a high-pressure hydrogen product stream enriched in hydrogen and a hydrogen-depleted tail gas stream; chilling a working fluid stream with a chilling stream in a first heat exchanger forming a chilled working fluid stream and a warmed chilling stream; chilling the hydrogen-depleted tail gas stream with the chilled working fluid stream in a main heat exchanger in a cryogenic carbon dioxide separation unit forming a chilled dried hydrogen-depleted tail gas stream and a warmed working fluid stream, and separating the chilled hydrogen-depleted tail gas stream into a carbon dioxide product stream comprising carbon dioxide, and an overhead stream; and passing the warmed working fluid stream to the first heat exchanger. An embodiment of the invention is one, any or all of prior embodiments in this paragraph up through the first embodiment in this paragraph wherein the chilling stream comprises liquefied natural gas, or liquid nitrogen, or liquid ammonia, or liquid hydrogen, or combinations thereof. An embodiment of the invention is one, any or all of prior embodiments in this paragraph up through the first embodiment in this paragraph wherein the working fluid stream comprises a hydrofluoroolefin, a hydrocarbon having 1 to 5 carbon atoms, or combinations thereof. An embodiment of the invention is one, any or all of prior embodiments in this paragraph up through the first embodiment in this paragraph further comprising separating the overhead stream in an overhead separation unit to form a low-pressure carbon dioxide stream enriched in carbon dioxide and an off-gas stream enriched in hydrogen and at least one of carbon monoxide and methane; and optionally recycling the low-pressure carbon dioxide stream to the cryogenic carbon dioxide separation unit. An embodiment of the invention is one, any or all of prior embodiments in this paragraph up through the first embodiment in this paragraph further comprising separating the off-gas stream in a second overhead separation unit to form a second hydrogen product stream and a second off-gas stream enriched in at least one of carbon monoxide and methane. An embodiment of the invention is one, any or all of prior embodiments in this paragraph up through the first embodiment in this paragraph further comprising passing the second off-gas stream to the synthesis gas production zone. An embodiment of the invention is one, any or all of prior embodiments in this paragraph up through the first embodiment in this paragraph further comprising passing at least a portion of the second hydrogen product stream to a process unit as fuel gas. An embodiment of the invention is one, any or all of prior embodiments in this paragraph up through the first embodiment in this paragraph wherein separating the synthesis gas in the hydrogen PSA unit to form the high-pressure hydrogen product stream and the hydrogen-depleted tail gas stream comprises separating the synthesis gas in the hydrogen PSA unit to form the high-pressure hydrogen product stream, the hydrogen-depleted tail gas stream, and a fuel gas stream, further comprising passing the fuel gas stream to a process unit as fuel gas. An embodiment of the invention is one, any or all of prior embodiments in this paragraph up through the first embodiment in this paragraph further comprising chilling a process stream with the warmed chilling stream after chilling the working fluid stream. An embodiment of the invention is one, any or all of prior embodiments in this paragraph up through the first embodiment in this paragraph wherein the process stream comprises the synthesis gas stream, a feed stream to a dehydration unit, a compressor discharge stream, or combinations thereof. An embodiment of the invention is one, any or all of prior embodiments in this paragraph up through the first embodiment in this paragraph wherein the chilling stream comprises liquified natural gas, further comprising passing the warmed chilling stream to the synthesis gas production zone after chilling the working fluid stream; or passing the warmed chilling stream to a natural gas network after chilling the working fluid stream; or both. An embodiment of the invention is one, any or all of prior embodiments in this paragraph up through the first embodiment in this paragraph further comprising compressing and drying the hydrogen-depleted tail gas stream to form a dried compressed tail gas stream; and wherein chilling the hydrogen-depleted tail gas stream with the chilled working fluid stream comprises chilling the dried compressed tail gas stream with the chilled working fluid stream. An embodiment of the invention is one, any or all of prior embodiments in this paragraph up through the first embodiment in this paragraph further comprising removing at least a portion of the water from the synthesis gas stream before separating the synthesis gas in the hydrogen PSA unit. An embodiment of the invention is one, any or all of prior embodiments in this paragraph up through the first embodiment in this paragraph wherein the first heat exchanger comprises a printed circuit heat exchanger, a shell and tube exchanger, a brazed aluminum exchanger, a spiral wound heat exchanger, or combinations thereof.

A second embodiment of the invention is a process for hydrogen production and carbon dioxide recovery comprising introducing a feed stream comprising hydrocarbons or a carbonaceous feedstock to a synthesis gas production zone comprising a syngas reactor to produce a synthesis gas stream comprising hydrogen, carbon dioxide, carbon monoxide, and methane; separating the synthesis gas stream in a hydrogen pressure swing adsorption (PSA) unit to form a high-pressure hydrogen product stream enriched in hydrogen and a hydrogen-depleted tail gas stream; compressing and drying the hydrogen-depleted tail gas stream to form a dried compressed tail gas stream; chilling a working fluid stream with a chilling stream comprising liquefied natural gas, or liquid nitrogen, or liquid ammonia, or liquid hydrogen, or combinations thereof in a first heat exchanger forming a chilled working fluid stream and a warmed chilling stream; chilling the dried compressed tail gas stream with the chilled working fluid stream in a main heat exchanger in a cryogenic carbon dioxide separation unit forming a chilled dried hydrogen-depleted tail gas stream and a warmed working fluid stream, and separating the chilled hydrogen-depleted tail gas stream into a carbon dioxide product stream comprising carbon dioxide, and an overhead stream; passing the warmed working fluid stream to the first heat exchanger; separating the overhead stream in an overhead separation unit to form a low-pressure carbon dioxide stream enriched in carbon dioxide and an off-gas stream enriched in hydrogen and at least one of carbon monoxide and methane; and optionally recycling the low-pressure carbon dioxide stream to the cryogenic carbon dioxide separation unit. An embodiment of the invention is one, any or all of prior embodiments in this paragraph up through the second embodiment in this paragraph wherein the working fluid stream comprises a hydrofluoroolefin, a hydrocarbon having 1 to 5 carbon atoms, or combinations thereof. An embodiment of the invention is one, any or all of prior embodiments in this paragraph up through the second embodiment in this paragraph further comprising separating the off-gas stream in a second overhead separation unit to form a second hydrogen product stream and a second off-gas stream enriched in at least one of carbon monoxide and methane; optionally passing the second off-gas stream to the synthesis gas production zone; optionally passing at least a portion of the second hydrogen product stream to a process unit as fuel gas. An embodiment of the invention is one, any or all of prior embodiments in this paragraph up through the second embodiment in this paragraph further comprising chilling a process stream with the warmed chilling stream after chilling the working fluid stream wherein the process stream comprises the synthesis gas stream, a feed stream to a dehydration unit, a compressor discharge stream, or combinations thereof. An embodiment of the invention is one, any or all of prior embodiments in this paragraph up through the second embodiment in this paragraph wherein the chilling stream comprises liquified natural gas, further comprising passing the warmed chilling stream to the synthesis gas production zone after chilling the working fluid stream; or passing the warmed chilling stream to a natural gas network after chilling a working fluid stream; or both. An embodiment of the invention is one, any or all of prior embodiments in this paragraph up through the second embodiment in this paragraph wherein the first heat exchanger comprises a printed circuit heat exchanger, a shell and tube exchanger, a brazed aluminum exchanger, a spiral wound heat exchanger, or combinations thereof.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. An integrated process for hydrogen production and carbon dioxide recovery comprising:
introducing a feed stream comprising hydrocarbons or a carbonaceous feedstock to a synthesis gas production zone comprising a syngas reactor to produce a synthesis gas stream comprising hydrogen, carbon dioxide, carbon monoxide, and methane;
separating the synthesis gas stream in a hydrogen pressure swing adsorption (PSA) unit to form a high-pressure hydrogen product stream enriched in hydrogen and a hydrogen-depleted tail gas stream;
chilling a working fluid stream with a chilling stream in a first heat exchanger forming a chilled working fluid stream and a warmed chilling stream;
chilling the hydrogen-depleted tail gas stream with the chilled working fluid stream in a main heat exchanger in a cryogenic carbon dioxide separation unit forming a chilled dried hydrogen-depleted tail gas stream and a warmed working fluid stream, and separating the chilled hydrogen-depleted tail gas stream into a carbon dioxide product stream comprising carbon dioxide, and an overhead stream; and
passing the warmed working fluid stream to the first heat exchanger.

2. The process of claim 1 wherein the chilling stream comprises liquefied natural gas, or liquid nitrogen, or liquid ammonia, or liquid hydrogen, or combinations thereof.

3. The process of claim 1 wherein the working fluid stream comprises a hydrofluoroolefin, a hydrocarbon having 1 to 5 carbon atoms, or combinations thereof.

4. The process of claim 1 further comprising:
separating the overhead stream in an overhead separation unit to form a low-pressure carbon dioxide stream enriched in carbon dioxide and an off-gas stream enriched in hydrogen and at least one of carbon monoxide and methane; and
optionally recycling the low-pressure carbon dioxide stream to the cryogenic carbon dioxide separation unit.

5. The process of claim 4 further comprising:
separating the off-gas stream in a second overhead separation unit to form a second hydrogen product stream and a second off-gas stream enriched in at least one of carbon monoxide and methane.

6. The process of claim 5 further comprising:
passing the second off-gas stream to the synthesis gas production zone.

7. The process of claim 5 further comprising:
passing at least a portion of the second hydrogen product stream to a process unit as fuel gas.

8. The process of claim 1 wherein separating the synthesis gas in the hydrogen PSA unit to form the high-pressure hydrogen product stream and the hydrogen-depleted tail gas stream comprises separating the synthesis gas in the hydrogen PSA unit to form the high-pressure hydrogen product stream, the hydrogen-depleted tail gas stream, and a fuel gas stream, further comprising:
passing the fuel gas stream to a process unit as fuel gas.

9. The process of claim 1 further comprising:
chilling a process stream with the warmed chilling stream after chilling the working fluid stream.

10. The process of claim 9 wherein the process stream comprises the synthesis gas stream, a feed stream to a dehydration unit, a compressor discharge stream, or combinations thereof.

11. The process of claim 1 wherein the chilling stream comprises liquified natural gas, further comprising:
passing the warmed chilling stream to the synthesis gas production zone after chilling the working fluid stream; or
passing the warmed chilling stream to a natural gas network after chilling the working fluid stream; or
both.

12. The process of claim 1 further comprising:
compressing and drying the hydrogen-depleted tail gas stream to form a dried compressed tail gas stream; and
wherein chilling the hydrogen-depleted tail gas stream with the chilled working fluid stream comprises chilling the dried compressed tail gas stream with the chilled working fluid stream.

13. The process of claim 1 further comprising:
removing at least a portion of the water from the synthesis gas stream before separating the synthesis gas in the hydrogen PSA unit.

14. The process of claim 1 wherein the first heat exchanger comprises a printed circuit heat exchanger, a shell and tube exchanger, a brazed aluminum exchanger, a spiral wound heat exchanger, or combinations thereof.

15. An integrated process for hydrogen production and carbon dioxide recovery comprising:
introducing a feed stream comprising hydrocarbons or a carbonaceous feedstock to a synthesis gas production zone comprising a syngas reactor to produce a synthesis gas stream comprising hydrogen, carbon dioxide, carbon monoxide, and methane;
separating the synthesis gas stream in a hydrogen pressure swing adsorption (PSA) unit to form a high-pressure hydrogen product stream enriched in hydrogen and a hydrogen-depleted tail gas stream;
compressing and drying the hydrogen-depleted tail gas stream to form a dried compressed tail gas stream;
chilling a working fluid stream with a chilling stream comprising liquefied natural gas, or liquid nitrogen, or liquid ammonia, or liquid hydrogen, or combinations thereof in a first heat exchanger forming a chilled working fluid stream and a warmed chilling stream;
chilling the dried compressed tail gas stream with the chilled working fluid stream in a main heat exchanger in a cryogenic carbon dioxide separation unit forming a chilled dried hydrogen-depleted tail gas stream and a warmed working fluid stream, and separating the chilled hydrogen-depleted tail gas stream into a carbon dioxide product stream comprising carbon dioxide, and an overhead stream;
passing the warmed working fluid stream to the first heat exchanger;
separating the overhead stream in an overhead separation unit to form a low-pressure carbon dioxide stream enriched in carbon dioxide and an off-gas stream enriched in hydrogen and at least one of carbon monoxide and methane; and
optionally recycling the low-pressure carbon dioxide stream to the cryogenic carbon dioxide separation unit.

16. The process of claim 15 wherein the working fluid stream comprises a hydrofluoroolefin, a hydrocarbon having 1 to 5 carbon atoms, or combinations thereof.

17. The process of claim 15 further comprising:
separating the off-gas stream in a second overhead separation unit to form a second hydrogen product stream and a second off-gas stream enriched in at least one of carbon monoxide and methane;
optionally passing the second off-gas stream to the synthesis gas production zone; and
optionally passing at least a portion of the second hydrogen product stream to a process unit as fuel gas.

18. The process of claim 15 further comprising:
chilling a process stream with the warmed chilling stream after chilling the working fluid stream wherein the process stream comprises the synthesis gas stream, a feed stream to a dehydration unit, a compressor discharge stream, or combinations thereof.

19. The process of claim 15 wherein the chilling stream comprises liquified natural gas, further comprising:
passing the warmed chilling stream to the synthesis gas production zone after chilling the working fluid stream; or
passing the warmed chilling stream to a natural gas network after chilling a working fluid stream; or
both.

20. The process of claim 1 wherein the first heat exchanger comprises a printed circuit heat exchanger, a shell and tube exchanger, a brazed aluminum exchanger, a spiral wound heat exchanger, or combinations thereof.
